(19) United States
(12) Patent Application Publication
(10) Pub. No.: US 2024/0037552 A1
(43) Pub. Date: Feb. 1, 2024

(54) METHOD AND SYSTEM FOR BLOCKING ILLEGAL WITHDRAWAL USING VIRTUAL ASSET DOUBLE PAYMENT PREVENTION POLICY

(71) Applicants: The Research & Business Development Center of KNPU, Asan-si (KR); Korea Internet & Security Agency, Naju-si (KR)

(72) Inventors: Cheol Hee YOON, Asan-si (KR); Gyeong Min BAEK, Seoul (KR); Dae Il JANG, Naju-si (KR); Yong Hee SHIN, Naju-si (KR)

(21) Appl. No.: 18/328,036

(22) Filed: Jun. 2, 2023

(30) Foreign Application Priority Data
Aug. 1, 2022 (KR) 10-2022-0095428

(51) Int. Cl. G06Q 20/40

(52) U.S. Cl. CPC G06Q 20/401

(57) ABSTRACT

The exemplary embodiments of the present disclosure provides a method and a system for blocking illegal withdrawal of a virtual asset by monitoring unapproved fraudulent transactions in which the virtual asset address managed by the virtual asset exchange connected to the virtual asset blockchain network is designated as the transfer address and restricting withdrawal transactions using a double payment prevention policy for unapproved illegal transactions.

### CROSS-REFERENCE TO RELATED APPLICATIONS

This application claims priority to and the benefit of Korean Patent Application No. 10-2022-0095428 filed in the Korean Intellectual Property Office on Aug. 1, 2022, the entire contents of which are incorporated herein by reference.

### BACKGROUND

### Field

A technical field of the present disclosure relates to a method and a system for blocking illegal withdrawal using a virtual asset double payment prevention policy.

This work was supported by Institute of Information and communications Technology Planning and Evaluation(IITP) grant funded by the Korea government(MSIT). (No.2020-0-00901, Information tracking technology related with cyber crime activity including illegal virtual asset transactions)

### Description of the Related Art

The contents described in this section merely provide background information on the present exemplary embodiment but do not constitute the related art.

The domestic virtual asset market continues to grow. As of the second half of 2021, the funds that flowed into the virtual asset market amounted to about 55 trillion won, and the average daily transaction size reached about 11 trillion won.

Due to its nature, virtual assets are easy to launder money and liquidate, and even if extortion occurs, it is difficult to properly track the virtual assets so that the virtual assets will be recognized as attractive targets for criminals. Just in the domestic virtual asset exchanges, there were virtual asset hacking incidents worth about 3.6 billion won in 2017 in the Coinrail Exchange, worth about 19 billion won in 2018 and about 22 billion won in 2019 in the Bithumb Exchange, and worth about 58 billion won in 2020 in the Upbit Exchange.

Criminals who hack virtual asset exchanges infiltrate the information and communication networks of virtual asset exchanges through long-term APT attacks, access PCs and servers of executives of the virtual asset exchanges and steal secret information, such as virtual asset wallet data.

FIG. 1 is a view illustrating a private key encryption method of a virtual currency wallet. Referring to FIG. 1, a secret key of an owner is stored in wallet data. If somebody knows the secret key, somebody can transfer virtual assets that can be certified as ownership with the secret key to others. However, In general, the secret key is bi-directionally encrypted with a symmetric key known only to the owner, so that it is almost impossible to transfer virtual assets with only the wallet data.

Unlike individuals, virtual asset exchanges generally manage symmetric key information using a key management system in the virtual asset exchange information and communication network to automatically process customer's withdrawal requests. Therefore, the technical difficulty of finding out the symmetric key that unidirectionally encrypts the secret key is not high for the criminal who has taken over the entire information and communication network of the virtual asset exchange through an APT attack. If the criminal steals the wallet information and symmetric key, the criminal may have the same rights as the legitimate owner, and transfer the owner's virtual assets to the criminal's virtual asset address. The criminal may generate a virtual asset transfer transaction using the stealing information and propagates to the blockchain network.

### RELATED ART DOCUMENT

### Patent Document

(Patent Document 1) Korean Registered Patent Publication No. 10-2113265 (May 14, 2020)

(Patent Document 2) Korean Registered Patent Publication No. 10-2142259 (Aug. 3, 2020)

(Patent Document 3) Korean Registered Patent Publication No. 10-2412444 (Jun. 20, 2022)

### SUMMARY

A main object of exemplary embodiments of the present disclosure is to block illegal withdrawal of virtual assets by monitoring unapproved illegal transactions in which the virtual asset address managed by the virtual asset exchange connected to the virtual asset blockchain network is designated as a transfer address and restricting withdrawal transactions using a double payment prevention policy for unapproved illegal transactions.

Other and further objects of the present disclosure which are not specifically described can be further considered within the scope easily deduced from the following detailed description and the effect.

According to an aspect of the present embodiment, a virtual asset illegal withdrawal blocking method by a virtual asset illegal withdrawal blocking system includes monitoring an unapproved illegal transaction in which a virtual asset address managed by a virtual asset exchange connected to a virtual asset blockchain network is designated as a transfer address; and restricting a withdrawal transaction using a double payment prevention policy for the unapproved illegal transaction.

The restricting of a withdrawal transaction includes creating transaction data in which a fee is set to be higher than a fee set by the unapproved illegal transaction. The restricting of a withdrawal transaction includes preferentially selecting a transaction with a high fee from a transaction candidate group in a verification process according to the double payment prevention policy by the virtual asset exchange device of the virtual asset illegal withdrawal blocking system.

The restricting of a withdrawal transaction includes blocking a withdrawal transaction without a legitimate authority by excluding a transaction with a low fee from the transaction candidate group.

The restricting of a withdrawal transaction includes suspending the disposition of the virtual asset for a lock time by adding a lock time parameter to a secret key corresponding to a transfer address of the unapproved illegal transaction.

Transaction data in which a fee is set to be higher than a fee set by the unapproved illegal transaction is created using a replace by fee (RBF) protocol of a Bitcoin and a BF flag may be forcibly set in a virtual asset wallet of the virtual asset address.

According to another aspect of the present embodiment, a virtual asset illegal withdrawal blocking system includes a cyber security device which monitors an unapproved illegal transaction in which a virtual asset address managed by a virtual asset exchange connected to a virtual asset blockchain network is designated as a transfer address; and a virtual asset exchange device which restricts a withdrawal transaction using a double payment prevention policy for the unapproved illegal transaction. The cyber security device creates transaction data in which a fee is set to be higher than a fee set by the unapproved illegal transaction.

The virtual asset exchange device preferentially selects a transaction with a high fee from a transaction candidate group during a verification process according to the double payment prevention policy.

The virtual asset exchange device blocks a withdrawal transaction without a legitimate authority by excluding a transaction with a low fee from the transaction candidate group.

The virtual asset exchange device suspends the disposition of the virtual asset for a lock time by adding a lock time parameter to a secret key corresponding to a transfer address of the unapproved illegal transaction.

Transaction data in which a fee is set to be higher than a fee set by the unapproved illegal transaction is created using a replace by fee (RBF) protocol of a Bitcoin and a BF flag may be forcibly set in a virtual asset wallet of the virtual asset address.

A cyber security device of the virtual asset illegal withdrawal blocking system is connected to a first block chain group and a virtual asset exchange device of the virtual asset illegal withdrawal blocking system is connected to a second blockchain group and

The 1-1-th gate block node and the 1-2-th gate block node belonging to the first block chain group may form a blockchain gate connection path in the 2-1-th gate block node and the 2-2-th gate block node belonging to the second block chain group.

The blockchain gate connection path may be connected in one of connection mode of a single line direct connection mode, a multiple line direct connection mode, a single line diagonal connection mode, and a multiple line diagonal connection mode.

As described above, according to the exemplary embodiments of the present disclosure, it is possible to block illegal withdrawal of virtual assets by monitoring unapproved illegal transactions in which the virtual asset address managed by the virtual asset exchange connected to the virtual asset blockchain network is designated as the sending address and restricting withdrawal transactions using a double payment prevention policy for unapproved illegal transactions.

Even if the effects are not explicitly mentioned here, the effects described in the following specification which are expected by the technical features of the present disclosure and their potential effects are handled as described in the specification of the present disclosure.

### BRIEF DESCRIPTION OF DRAWINGS

FIG. 1 is a view illustrating a private key encryption method of a virtual currency wallet;

FIG. 2 is a view illustrating a virtual asset illegal withdrawal blocking system according to an exemplary embodiment of the present disclosure;

FIGS. 3 and 4 are flowcharts illustrating a virtual asset illegal withdrawal blocking method according to another exemplary embodiment of the present disclosure;

FIG. 5 is a view illustrating transaction propagation of a blockchain network to which a virtual asset illegal withdrawal blocking method according to another exemplary embodiment of the present disclosure is applied;

FIG. 6 is a view illustrating a blockchain group and a block node to which a virtual asset illegal withdrawal blocking system according to another exemplary embodiment of the present disclosure is applied; and

FIG. 7 is a block diagram illustrating a computing device which carries out exemplary embodiments of the present disclosure.

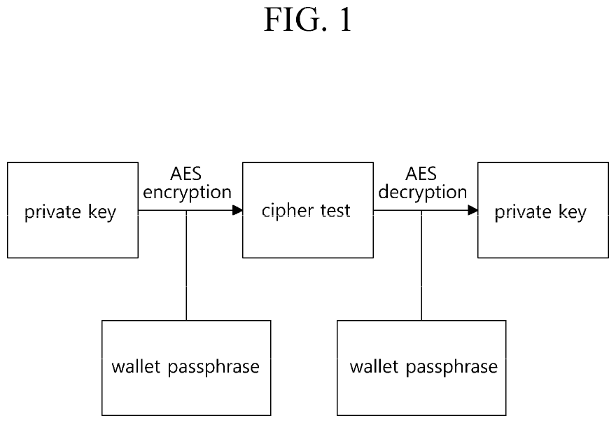

### DETAILED DESCRIPTION OF THE EMBODIMENT

Hereinafter, in the description of the present disclosure, a detailed description of the related known functions will be omitted if it is determined that the gist of the present disclosure may be unnecessarily blurred as it is obvious to those skilled in the art and some exemplary embodiments of the present disclosure will be described in detail with reference to exemplary drawings.

Double payment problems may occur during the process of virtual currency transaction. Double payment refers to a problem in which virtual asset owners can transfer the same asset to multiple recipients at the same time, which is blocked by centralized management methods in traditional financial systems and is blocked by decentralized management methods in blockchain networks.

In order to block the double payment problem, the blockchain network does not immediately trust a new transaction even if it is incorporated into a block, but requires that a block containing a specific transaction undergo additional verification several times from other nodes.

In the case of Bitcoin, after a transaction is included in a block and propagated, it must be verified for at least six blocks to be recognized as a reliable transaction. Before the transaction is incorporated into the block, the double payment problem may occur.

If a virtual asset owner propagates a transaction that transfers the same asset to several recipients, all the transactions are stores in Mempool as a candidate group which can be incorporated into a new block. A mining node selects a transaction to be incorporated based on fees, transaction creation time (transaction age), etc. and if the transaction age is not high, the transaction fee is an important criterion.

The purpose of mining by nodes in the blockchain network is to obtain compensation for newly created blocks and to take fees for transactions incorporated into blocks. Accordingly, the mining node preferentially selects a transaction with a high fee from the Mempool.

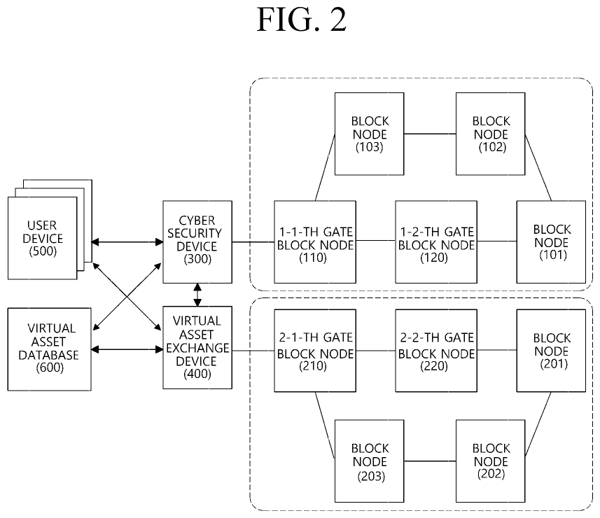

FIG. 2 is a view illustrating a virtual asset illegal withdrawal blocking system according to an exemplary embodiment of the present disclosure.

A virtual asset illegal withdrawal blocking system includes a cyber security device 300, a virtual asset exchange device 400, a plurality of user devices 500, and a virtual asset database 600.

The cyber security device 300 monitors an unproved illegal transaction in which a virtual asset address managed by a virtual asset exchange connected to a virtual asset blockchain network is designated as a transfer address.

The cyber security device 300 restricts a withdrawal transaction using the double payment prevention policy for the unapproved illegal transaction.

The cyber security device 300 creates transaction data in which a fee is set to be higher than a fee set in the unapproved illegal transaction. The virtual asset exchange device 400 preferentially selects a transaction with a high fee from a transaction candidate group during a verification process according to the double payment prevention policy. The virtual asset exchange device 400 blocks a withdrawal transaction without legitimate authority by excluding other low-fee transactions from the transaction candidate group.

Even after blocking the withdrawal transaction without legitimate authority, the same unapproved illegal transaction may be attempted. Accordingly, the virtual asset exchange device 400 adds a lock time parameter to a secret key corresponding to the transfer address of the unapproved illegal transaction to stop the disposition of the virtual asset for the lock time.

The act of transferring virtual assets without legitimate authority can be blocked using the process of verifying virtual asset double payment.

The virtual asset exchange operates a plurality of nodes in various locations to monitor the Mempool and if an unapproved illegal transaction in which the virtual asset address is designated as a transfer address is confirmed, creates transaction data with a fee set to be higher than the fee set by the unapproved illegal transaction to attempt the double payment. In this case, the mining node preferentially selects the transaction with a high fee from the Mempool so that the Transactions of persons without legitimate authority will be excluded from the Mempool due to verification failure due to double payment. Understanding the characteristics of the Mempool in the proximity of the transaction can improve the method of tracking additional virtual asset illegal transactions.

In order to create a transaction in which a fee is set to be higher than a fee set by the unapproved illegal transaction, a replace by fee (RBF) protocol of the Bitcoin may be used. The RBF is a function of the Bitcoin to replace a transaction which is not confirmed with a new transaction including a higher fee and is introduced to solve the problem of congested or slow Bitcoin transactions. In the Bitcoin network, the transaction is confirmed by the mining node. However, when the network is congested or a transaction fee is set to be low, it takes long time to confirm the transaction or the transaction may remain in unconfirmed indefinitely. The RBF protocol is introduced as a solution for this problem. In order to use the RBF in the Bitcoin, a RBF flag is set when the transaction is created or an RBF flag is set in the virtual asset wallet.

In order to allow the cyber security device 300 to create transaction data in which a fee is set to be higher than the fee set by the unapproved illegal transaction, the virtual asset exchange device may forcibly set the RBF flag of the virtual asset address of a virtual asset address managed by the virtual asset exchange.

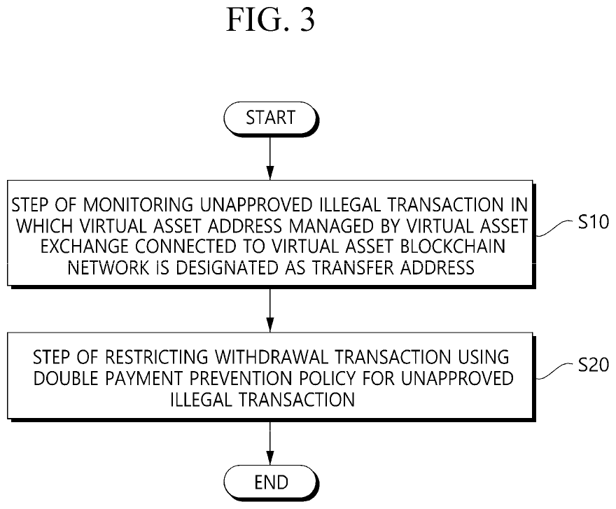

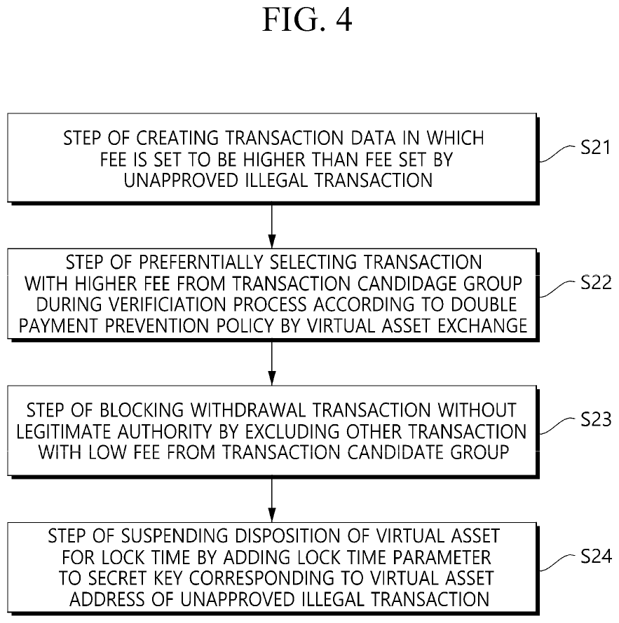

FIGS. 3 and 4 are flowcharts illustrating a virtual asset illegal withdrawal prevention method according to another exemplary embodiment of the present disclosure.

A virtual asset illegal withdrawal blocking method may be performed by a virtual asset illegal withdrawal blocking system.

Referring to FIG. 3, in step S10, a step of monitoring an unapproved illegal transaction in which a virtual asset address managed by a virtual asset exchange connected to a virtual asset blockchain network is designated as a transfer address is performed. Here, a BF flag may be forcibly set in a virtual asset wallet of the virtual asset address.

In step S20, a step of restricting a withdrawal transaction using a double payment prevention policy for the unapproved illegal transaction is performed.

Referring to FIG. 3, the step of restricting a withdrawal transaction includes a step S21 of creating transaction data in which a fee is set to be higher than the fee set in the unapproved illegal transaction.

The step of restricting a withdrawal transaction includes a step S22 of preferentially selecting a transaction with a high fee from a transaction candidate group in a verification process according to the double payment prevention policy by the virtual asset exchange device of the virtual asset illegal withdrawal blocking system.

The step of restricting a withdrawal transaction may include a step S23 of blocking a withdrawal transaction without a legitimate authority by excluding the other transaction with a low fee from the transaction candidate group.

The step of restricting a withdrawal transaction includes a step of suspending the disposition of the virtual asset for a lock time by adding a lock time parameter to a secret key corresponding to a transfer address of the unapproved illegal transaction.

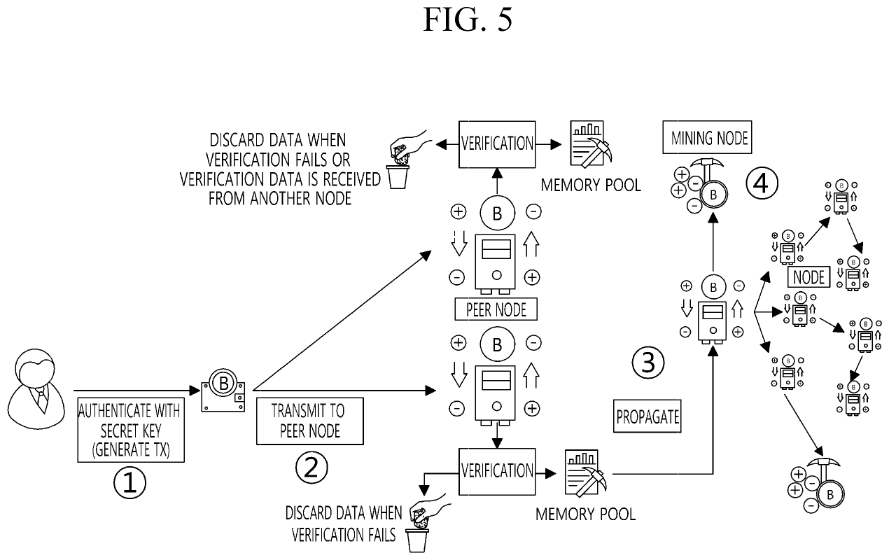

FIG. 5 is a view illustrating transaction propagation of a blockchain network to which a virtual asset illegal withdrawal prevention method according to another exemplary embodiment of the present disclosure is applied.

A node which receives the transaction data performs a verification process confirming whether a transfer address possesses a transmittable amount of virtual assets and then stores the transaction data in a transaction candidate group (Mempool) to be included in a newly created block. When a mining node mines a new block, the mining node selects a transaction having a higher priority to propagate the completed block data to a blockchain network.

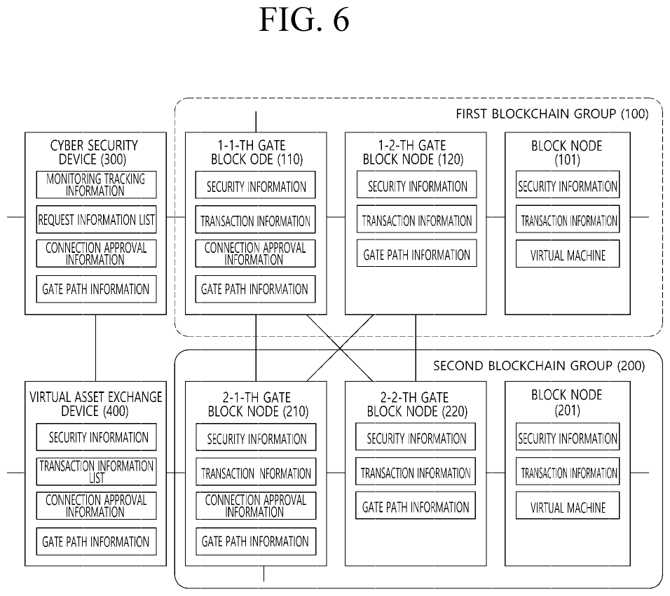

FIG. 6 is a view illustrating a blockchain group and a block node to which a virtual asset illegal withdrawal prevention system according to another exemplary embodiment of the present disclosure is applied.

A cyber security device 300 of the virtual asset illegal withdrawal blocking system is connected to a first blockchain group 100 and a virtual asset exchange device 400 of the virtual asset tracking system is connected to a second blockchain group 200.

The cyber security device 300 includes monitoring tracking information, a request information list, connection approval information, gate path information. The virtual asset exchange device 400 includes security information, a transaction information list, connection approval information, gate path information.

The first blockchain group 100 includes a 1-1-th gate block node 110, a 1-2-th gate block node 120, and a plurality of block nodes 101. The second blockchain group 200 includes a 2-1-th gate block node 210, a 2-2-th gate block node 220, and a plurality of block nodes 201. The 1-1-th gate block node 110 includes security information, transaction information, transaction approval information, and gate path information. The 1-2-th gate block node 120 includes security information, transaction information, and gate path information. The block node of the first blockchain group 100 includes security information, transaction information, and a virtual machine.

The second blockchain group 200 includes a 2-1-th gate block node 210, a 2-2-th gate block node 220, and a plurality of block nodes 201. The 2-1-th gate block node 210 includes security information, transaction information, transaction approval information, and gate path information. The 2-2-th gate block node 220 includes security information, transaction information, and gate path information. The block node of the second blockchain group 200 includes security information, transaction information, and a virtual machine.

The security information stored in the virtual asset exchange device, the 1-1-th gate block node, the 1-2-th gate block node, the 2-1-th gate block node, the 2-2-th gate block node, and the block node is information used for encryption/decryption, such as a hash value.

The transaction information which is distributed to be stored in the 1-1-th gate block node, the 1-2-th gate block node, the 2-1-th gate block node, the 2-2-th gate block node, and the block node corresponds to transaction data and includes contents regarding a source, a destination, and an amount.

The transaction information list stored in the virtual asset exchange device is metadata about transaction information which is distributed to be stored in the 1-1-th gate block node, the 1-2-th gate block node, the 2-1-th gate block node, the 2-2-th gate block node, and the block node. The transaction information list allows knowing transaction information possessed by an arbitrary block node and provides a criterion for determining a consensus algorithm.

A virtual machine which is stored and installed in a block node of the first blockchain group and a block node of the second blockchain group is an execution environment which operates as software which executes a source code.

Connection approval information stored in the cyber security device and the 1-1-th gate block node is information regarding a series of procedures required to connect the first blockchain group.

The connection approval information stored in the cyber security device and the 2-1-th gate block node is information regarding a series of procedures required to connect the first blockchain group.

The gate path information stored in the cyber security device, the 1-1-th gate block node, the 1-2-th gate block node, and the virtual asset exchange device is information about a path formed between the cyber security device and the virtual asset exchange device, and a path formed between the first block chain group and the second block chain group.

The 1-1-th gate block node and the 1-2-th gate block node belonging to the first block chain group may form a blockchain gate connection path in the 2-1-th gate block node and the 2-2-th gate block node belonging to the second block chain group.

The blockchain gate connection path may be connected in one of connection mode of a single line direct connection mode, a multiple line direct connection mode, a single line diagonal connection mode, and a multiple line diagonal connection mode.

The single line direct connection mode relates to a path which connects the 1-1-th gate block node and the 2-1-th gate block node or connects the 1-2-th gate block node and the 2-2-th gate block node.

The multiple line direct connection mode relates to a path which simultaneously connects the 1-1-th gate block node and the 2-1-th gate block node and connects the 1-2-th gate block node and the 2-2-th gate block node.

The single line diagonal connection mode relates to a path which connects the 1-1-th gate block node and the 2-2-th gate block node or connects the 1-2-th gate block node and the 2-1-th gate block node.

The multiple line diagonal connection mode relates to a path which simultaneously connects the 1-1-th gate block node and the 2-2-th gate block node and connects the 1-2-th gate block node and the 2-1-th gate block node.

The gate connection path may include a flat regarding a connection mode of a single line direct connection mode, a multiple line direct connection mode, a single line diagonal connection mode, or a multiple line diagonal connection mode.

Even though components included in the virtual asset illegal withdrawal blocking system are separately illustrated in FIG. 2, the plurality of components is coupled to each other to be implemented by at least one module. The components are connected to a communication path which connects a software module or a hardware module in the apparatus to organically operate between the components. The components communicate with each other using one or more communication buses or signal lines.

The virtual asset illegal withdrawal blocking system may be implemented in a logic circuit by hardware, firm ware, software, or a combination thereof or may be implemented using a general purpose or special purpose computer. The device may be implemented using hardwired device, field programmable gate array (FPGA) or application specific integrated circuit (ASIC). Further, the device may be implemented by a system on chip (SoC) including one or more processors and a controller.

The virtual asset illegal withdrawal blocking system may be mounted in a computing device or a server provided with a hardware element as a software, a hardware, or a combination thereof. The computing device or server may refer to various devices including all or some of a communication device for communicating with various devices and wired/wireless communication networks such as a communication modem, a memory which stores data for executing programs, and a microprocessor which executes programs to perform operations and commands.

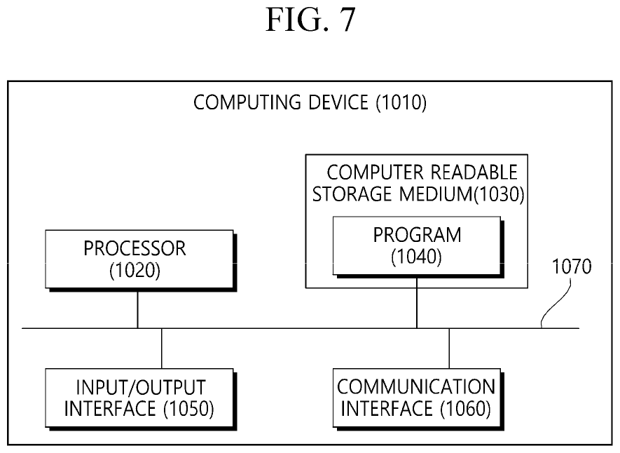

FIG. 7 is a block diagram illustrating a computing device which carries out exemplary embodiments of the present disclosure.

The computing device 1010 includes at least one processor 1020, a computer readable storage medium 1030, and a communication bus 1070.

The processor 1020 controls the computing device 1010 to operate. For example, the processor 1020 may execute one or more programs stored in the computer readable storage medium 1030. One or more programs may include one or more computer executable instructions and the computer executable instruction may be configured to allow the computing device 1010 to perform the operations according to the exemplary embodiments when it is executed by the processor 1020.

The computer readable storage medium 1030 is configured to store a computer executable instruction or program code, program data and/or other appropriate format of information. The program 1030 stored in the computer readable storage medium 1040 includes a set of instructions executable by the processor 1020. In one exemplary embodiment, the computer readable storage medium 1030 may be a memory (a volatile memory such as a random access memory, a non-volatile memory, or an appropriate combination thereof), one or more magnetic disk storage devices, optical disk storage devices, flash memory devices, and another format of storage mediums which is accessed by the computing device 1010 and stores desired information, or an appropriate combination thereof.

The communication bus 1070 includes a processor 1020 and a computer readable storage medium 1040 to interconnect various components of the computing device 1010 to each other.

The computing device 1010 may include one or more input/output interfaces 1050 and one or more communication interfaces 1060 which provide an interface for one or more input/output devices. The input/output interface 1050 and the communication interface 1060 are connected to the communication bus 1070. The input/output device (not illustrated) may be connected to the other components of the computing device 1010 by means of the input/output interface 1050.

In FIGS. 3 and 4, the respective processes are sequentially performed, but this is merely illustrative and those skilled in the art may apply various modifications and changes by changing the order illustrated in FIGS. 3 and 4 or performing one or more processes in parallel or adding another process without departing from the essential gist of the exemplary embodiment of the present disclosure. The operation according to the exemplary embodiment of the present disclosure may be implemented as a program instruction which may be executed by various computers to be recorded in a computer readable medium. The computer readable medium indicates an arbitrary medium which participates to provide a command to a processor for execution. The computer readable medium may include solely a program command, a data file, and a data structure or a combination thereof. For example, the computer readable medium may include a magnetic medium, an optical recording medium, and a memory. The computer program may be distributed on a networked computer system so that the computer readable code may be stored and executed in a distributed manner. Functional programs, codes, and code segments for implementing the present embodiment may be easily inferred by programmers in the art to which this embodiment belongs.

The present embodiments are provided to explain the technical spirit of the present embodiment and the scope of the technical spirit of the present embodiment is not limited by these embodiments. The protection scope of the present embodiments should be interpreted based on the following appended claims and it should be appreciated that all technical spirits included within a range equivalent thereto are included in the protection scope of the present embodiments.

### Statement Regarding Prior Disclosures by the Inventor or a Joint Inventor

The inventors of the present application have made related disclosure in JANG DAEIL et. al., “A study on the development direction of response technology in response to the increase in virtual asset cybercrime abuse,” The Proceedings of the 2022 KIIT Summer Conference, Vol. 17, No. 1, ISSN 2005-7334, Jun. 3, 2022. The related disclosure was made less than one year before the effective filing date (Aug. 1, 2022) of the present application and the inventors of the present application are the same as those of the related disclosure. Accordingly, the related disclosure is disqualified as prior art under 35 USC 102(a)(1) against the present application. See 35 USC 102(b)(1) (A).

What is claimed is:

1. A virtual asset illegal withdrawal blocking method by a virtual asset illegal withdrawal blocking system, comprising:
monitoring an unapproved illegal transaction in which a virtual asset address managed by a virtual asset exchange connected to a virtual asset blockchain network is designated as a transfer address; and
restricting a withdrawal transaction using a double payment prevention policy for the unapproved illegal transaction.

2. The virtual asset illegal withdrawal blocking method according to claim 1, wherein the restricting of a withdrawal transaction includes:
creating transaction data in which a fee is set to be higher than a fee set by the unapproved illegal transaction.

3. The virtual asset illegal withdrawal blocking method according to claim 2, wherein the restricting of a withdrawal transaction includes:
preferentially selecting a transaction with a high fee from a transaction candidate group in a verification process according to the double payment prevention policy by the virtual asset exchange device of the virtual asset illegal withdrawal blocking system.

4. The virtual asset illegal withdrawal blocking method according to claim 3, wherein the restricting of a withdrawal transaction includes:
blocking a withdrawal transaction without a legitimate authority by excluding a transaction with a low fee from the transaction candidate group.

5. The virtual asset illegal withdrawal blocking method according to claim 4, wherein the restricting of a withdrawal transaction includes:
suspending the disposition of the virtual asset for a lock time by adding a lock time parameter to a secret key corresponding to a transfer address of the unapproved illegal transaction.

6. The virtual asset illegal withdrawal blocking method according to claim 4, wherein transaction data in which a fee is set to be higher than a fee set by the unapproved illegal transaction is created using a replace by fee (RBF) protocol of a Bitcoin and a RBF flag is forcibly set in a virtual asset wallet of the virtual asset address.

7. The virtual asset illegal withdrawal blocking method according to claim 1, wherein a cyber security device of the virtual asset illegal withdrawal blocking system is connected to a first block chain group and a virtual asset exchange device of the virtual asset illegal withdrawal blocking system is connected to a second blockchain group and a 1-1-th gate block node and a 1-2-th gate block node belonging to the first block chain group form a blockchain gate connection path in a 2-1-th gate block node and a 2-2-th gate block node belonging to the second block chain group.

8. The virtual asset illegal withdrawal blocking method according to claim 7, wherein the blockchain gate connection path is connected in one of connection mode of a single line direct connection mode, a multiple line direct connection mode, a single line diagonal connection mode, and a multiple line diagonal connection mode.

9. A virtual asset illegal withdrawal blocking system, comprising:
a cyber security device which monitors an unapproved illegal transaction in which a virtual asset address managed by a virtual asset exchange connected to a virtual asset blockchain network is designated as a transfer address; and
a virtual asset exchange device which restricts a withdrawal transaction using a doubly payment prevention system for the unapproved illegal transaction.

10. The virtual asset illegal withdrawal blocking system according to claim 9, wherein the cyber security device creates transaction data in which a fee is set to be higher than a fee set by the unapproved illegal transaction.

11. The virtual asset illegal withdrawal blocking system according to claim 10, wherein the virtual asset exchange device preferentially selects a transaction with a high fee from a transaction candidate group during a verification process according to the double payment prevention policy.

12. The virtual asset illegal withdrawal blocking system according to claim 11, wherein the virtual asset exchange device blocks a withdrawal transaction without a legitimate authority by excluding a transaction with a low fee from the transaction candidate group.

13. The virtual asset illegal withdrawal blocking system according to claim 12, wherein the virtual asset exchange device suspends the disposition of the virtual asset for a lock time by adding a lock time parameter to a secret key corresponding to a transfer address of the unapproved illegal transaction.

14. The virtual asset illegal withdrawal blocking system according to claim 12, wherein transaction data in which a fee is set to be higher than a fee set by the unapproved illegal transaction is created using a replace by fee (RBF) protocol of a Bitcoin and a RBF flag is forcibly set in a virtual asset wallet of the virtual asset address.

15. The virtual asset illegal withdrawal blocking system according to claim 9, wherein the cyber security device is connected to a first blockchain group and the virtual asset exchange device is connected to a second blockchain group, and a 1-1-th gate block node and a 1-2-th gate block node belonging to the first block chain group form a blockchain gate connection path in a 2-1-th gate block node and a 2-2-th gate block node belonging to the second block chain group.

16. The virtual asset illegal withdrawal blocking system according to claim 15, wherein the blockchain gate connection path is connected in one of connection mode of a single line direct connection mode, a multiple line direct connection mode, a single line diagonal connection mode, and a multiple line diagonal connection mode.
